(19) United States
(12) Patent Application Publication
(10) Pub. No.: US 2019/0349320 A1
(43) Pub. Date: Nov. 14, 2019

(54) SYSTEM AND METHOD FOR AUTOMATICALLY RESPONDING TO USER REQUESTS

(71) Applicant: MZ IP Holdings, LLC, Palo Alto, CA (US)

(72) Inventors: Satheeshkumar Karuppusamy, San Jose, CA (US); Nikhil Londhe, San Francisco, CA (US); Nikhil Bojja, Mountain View, CA (US)

(21) Appl. No.: 16/395,796

(22) Filed: Apr. 26, 2019

Related U.S. Application Data
(60) Provisional application No. 62/668,561, filed on May 8, 2018.

(51) Int. Cl. H04L 12/58; G06F 17/27; G06F 16/332; G06F 16/338

(52) U.S. Cl. CPC H04L 51/02; H04L 51/046; G06F 16/338; G06F 16/3329; G06F 17/27

(57) ABSTRACT

A method, a system, and an article are provided for automatically responding to requests from users in an online messaging system. An example method includes: providing an online messaging system; receiving a new request from a user in the online messaging system; determining that the new request is suitable for an automatic response to the user based on at least one of a request category, a request length, or a request sentiment; retrieving, from a database, a previous automatic response associated with a previous request that is similar to the new request; and providing the retrieved previous automatic response to the user in the online messaging system.

### CROSS-REFERENCE TO RELATED APPLICATIONS

This application claims the benefit of U.S. Provisional Patent Application No. 62/668,561, filed May 8, 2018, the entire contents of which are incorporated by reference herein.

### BACKGROUND

The present disclosure relates generally to providing automatic responses to messages received from users of an online messaging system and, in certain examples, to systems and methods for building and using a database for providing the automatic responses.

In general, many businesses operate websites or other online portals that allow users to submit requests regarding the businesses' products or services. The businesses can utilize teams of customer service representatives who review and respond to the user requests, which can include questions and/or descriptions of various issues encountered by the users. A business that provides a software application, for example, can provide an online portal (e.g., a “contact us” webpage) that allows users to discuss the software application with customer service representatives. Given the wide variety and large volume of possible questions, however, it can be difficult for the customer service representatives to provide prompt and accurate responses to the user requests.

### SUMMARY

In general, the subject matter of this disclosure relates to online systems and methods for providing automatic responses to requests (e.g., text messages) received from users. The systems and methods can utilize a messaging website or other online messaging system configured to allow users to generate and submit the requests. The systems and methods can process each new request to determine whether or not the request is suitable for an automatic response. The systems and methods can make this determination, for example, by analyzing the request to identify a subject matter, a length, and/or a sentiment associated with the request. When the request is determined to be suitable for an automatic response, an appropriate automatic response can be retrieved (e.g., from a database) and provided to the user in the messaging system. The automatic response can be retrieved by (i) identifying at least one previous or existing request that is similar to the new request and (ii) identifying the automatic response that is associated with the at least one previous request.

Advantageously, the systems and methods described herein are able to achieve significant improvements in efficiency and accuracy associated with automatically responding to requests from users in an online messaging system. The systems and methods are able to take advantage of similarities that exist among requests from users. For example, when a user submits a new request that is similar to a previous request for which an approved response is known, the systems and methods are able to recognize the similarities (e.g., in words, phrases, or other content) between the new request and the previous request and identify the approved response as likely being suitable for the new request. The approved response can then be automatically sent to the user, preferably without any manual review. If the user provides feedback indicating the user is not satisfied with the automatic response, however, the request can be reviewed manually and a manual response can be provided to the user. Advantageously, as new requests are received and new responses are generated, the underlying database of requests and automatic responses can be augmented and improved. This allows the systems and methods to continuously improve and adapt, so that automatic responses can be provided to address new user questions and issues when they appear. The systems and methods described herein achieve significant improvements in precision, accuracy, and efficiency associated with automatically responding to user requests in an online messaging system.

In one aspect, the subject matter described in this specification relates to a method (e.g., a computer-implemented method). The method includes: providing an online messaging system; receiving a new request from a user in the online messaging system; determining that the new request is suitable for an automatic response to the user based on at least one of a request category, a request length, or a request sentiment; retrieving, from a database, a previous automatic response associated with a previous request that is similar to the new request; and providing the retrieved previous automatic response to the user in the online messaging system.

In certain examples, the online messaging system can be provided to support users of a client application. Determining that the new request is suitable for the automatic response can include: assigning the new request to a category from a plurality of categories; and determining that the category is suitable for the automatic response. Determining that the new request is suitable for the automatic response can include determining that a length of the new request is less than a threshold request length. Determining that the new request is suitable for the automatic response can include performing a sentiment analysis on the new request.

In some implementations, retrieving the previous automatic response can include: searching the database for the previous request that is similar to the new request; and retrieving the previous automatic response based on a mapping between the previous request and the previous automatic response. Searching the database for the previous request can include: extracting a plurality of tags from the new request; and calculating a cosine similarity between the plurality of tags for the new request and a corresponding plurality of tags for the previous request. At least one tag in the plurality of tags for the new request can be or include a word frequency or a phrase frequency. The method can include updating the database to include a mapping between the new request and the previous automatic response. The method can include: receiving a new automatic response for the online messaging system; mapping the new automatic response to at least one user request; and updating the database to include the mapping between the new automatic response and the at least one user request.

In another aspect, the subject matter described in this specification relates to a system having one or more computer processors programmed to perform operations including: providing an online messaging system; receiving a new request from a user in the online messaging system; determining that the new request is suitable for an automatic response to the user based on at least one of a request category, a request length, or a request sentiment; retrieving, from a database, a previous automatic response associated with a previous request that is similar to the new request; and providing the retrieved previous automatic response to the user in the online messaging system.

In various implementations, the online messaging system can be provided to support users of a client application. Determining that the new request is suitable for the automatic response can include: assigning the new request to a category from a plurality of categories; and determining that the category is suitable for the automatic response. Determining that the new request is suitable for the automatic response can include determining that a length of the new request is less than a threshold request length. Determining that the new request is suitable for the automatic response can include performing a sentiment analysis on the new request.

In certain examples, retrieving the previous automatic response can include: searching the database for the previous request that is similar to the new request; and retrieving the previous automatic response based on a mapping between the previous request and the previous automatic response. Searching the database for the previous request can include: extracting a plurality of tags from the new request; and calculating a cosine similarity between the plurality of tags for the new request and a corresponding plurality of tags for the previous request. At least one tag in the plurality of tags for the new request can be or include a word frequency or a phrase frequency. The operations can include updating the database to include a mapping between the new request and the previous automatic response. The operations can include: receiving a new automatic response for the online messaging system; mapping the new automatic response to at least one user request; and updating the database to include the mapping between the new automatic response and the at least one user request.

In another aspect, the subject matter described in this specification relates to an article. The article includes a non-transitory computer-readable medium having instructions stored thereon that, when executed by one or more computer processors, cause the computer processors to perform operations including: providing an online messaging system; receiving a new request from a user in the online messaging system; determining that the new request is suitable for an automatic response to the user based on at least one of a request category, a request length, or a request sentiment; retrieving, from a database, a previous automatic response associated with a previous request that is similar to the new request; and providing the retrieved previous automatic response to the user in the online messaging system.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### DESCRIPTION OF THE DRAWINGS

FIG. 1 is a schematic diagram of an example system for automatically responding to requests from users in an online messaging system.

FIG. 2 is a schematic data flow diagram of an example system for automatically responding to requests from users in an online messaging system.

FIG. 3 is a schematic data flow diagram of an example system for building a database used to provide automatic responses to requests from users in an online messaging system.

FIG. 4 is a schematic flowchart of a method of automatically responding to a request from a user in an online messaging system.

FIG. 5 is a schematic data flow diagram of an example system for automatically responding to requests from users in different languages, in an online messaging system.

FIG. 6 is a schematic data flow diagram of an example system for automatically generating responses to user requests in an online messaging system.

FIG. 7 is a flowchart of an example method of automatically responding to requests from users in an online messaging system.

### DETAILED DESCRIPTION

In various examples, the subject matter of this disclosure relates to systems and methods for automatically responding to requests or messages received from users in an online messaging system. The requests can be text messages and/or can include other content, such as images, emoji, video, and/or audio. In general, a request can be or include a message from a user that describes a question and/or an issue being experienced by the user. In the context of an online messaging system for a software application, for example, the request can include a question related to the software application. The systems and methods described herein can analyze the request and identify a suitable automatic response, which can be provided to the user in the online messaging system. The user can have an opportunity to provide feedback regarding the utility or relevance of the automatic response.

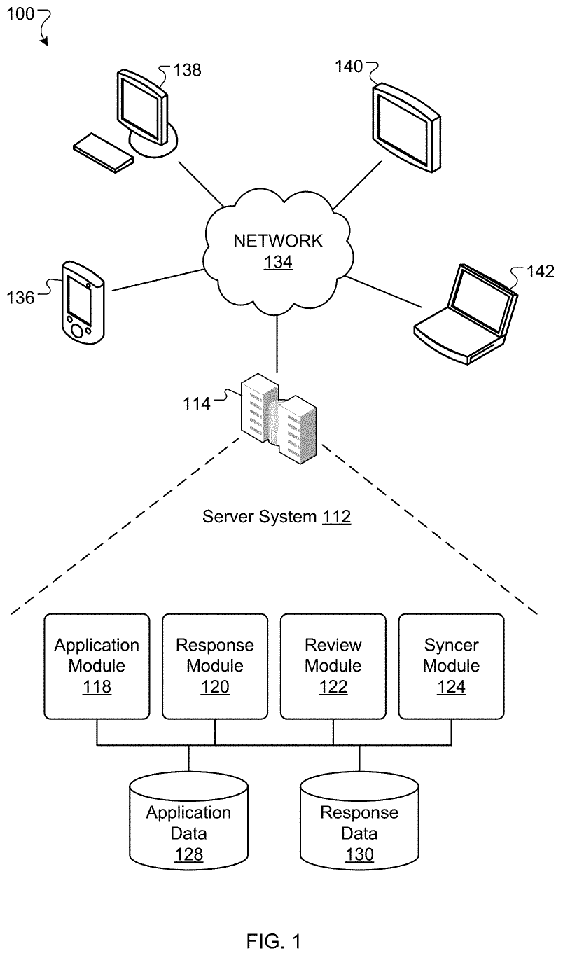

FIG. 1 illustrates an example system 100 for automatically responding to requests from users of a software application or other product or service. A server system 112 provides functionality for building a database of responses and using the database to generate automatic responses to user requests. The server system 112 includes software components and databases that can be deployed at one or more data centers 114 in one or more geographic locations, for example. In certain instances, the server system 112 is, includes, or utilizes a content delivery network (CDN). The server system 112 software components can include an application module 118, a response module 120, a review module 122, and a syncer module 124. The software components can include subcomponents that can execute on the same or on different individual data processing apparatus. The server system 112 databases can include an application data 128 database and a response data 130 database. The databases can reside in one or more physical storage systems. The software components and data will be further described below.

The software application can be a client-based application (e.g., a mobile application) or a web-based software application and/or can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the software application is a mobile application for a computer game, such as a multiplayer online game. The software application or components thereof can be accessed through a network 134 (e.g., the Internet) by users of client devices, such as a smart phone 136, a personal computer 138, a tablet computer 140, and a laptop computer 142. Other client devices are possible. In alternative examples, the application data 128 database, the response data 130 database, or any portions thereof can be stored on one or more client devices. Additionally or alternatively, software components for the system 100 (e.g., the application module 118, the response module 120, the review module 122, and/or the syncer module 124) or any portions thereof can reside on or be used to perform operations on one or more client devices.

FIG. 1 depicts the application module 118, the response module 120, the review module 122, and the syncer module 124 as being able to communicate with the application data 128 database and the response data 130 database. The application data 128 database generally includes data used to implement the software application on the system 100. Such data can include, for example, image data, video data, audio data, application parameters, initialization data, and/or any other data used to run the software application. The response data 130 database generally includes information related to user requests and responses to the requests. The information can be or include, for example, a history of user requests and any responses to the request. In certain examples, the information includes a mapping between previous user requests and preferred or approved responses for the requests. The information can include feedback from users regarding the relevance of any automatic responses provided to the users. In various examples, information in the databases can be tagged and/or indexed to facilitate data retrieval, for example, using ELASTICSEARCH or other search engines.

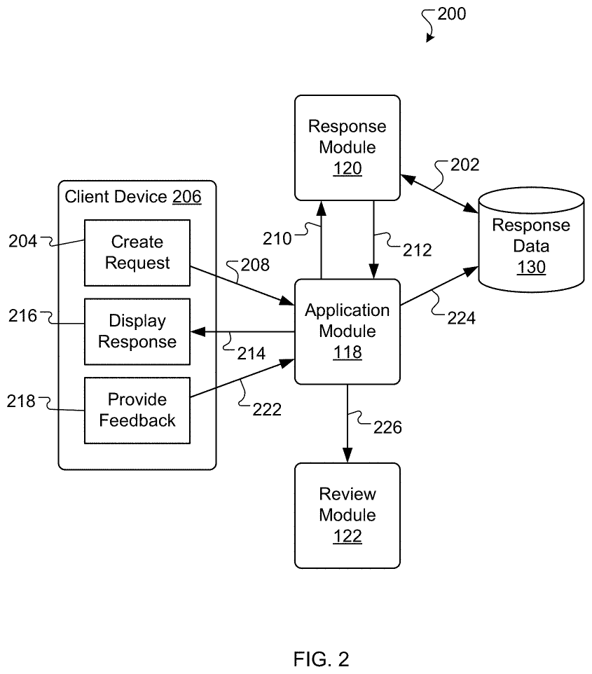

FIG. 2 is a schematic data flow diagram of a method 200 in which the application module 118, the response module 120, the review module 122, and the response data 130 database are used to generate and provide automatic responses to requests from users. To initiate the method 200, the response module 120 can access or obtain (step 202) a set of most recent response data from the response data 130 database. The response data can include responses that have been approved for providing automatic responses to user requests. The response data 130 database can map or link each automatic response to one or more user requests, such as previous requests that have been received from users. In some examples, the response module 120 can include one or more models or classifiers that are trained using data from the response data 130 database.

Next, a user can create a request (step 204) on a client device 206 (e.g., using an application client for the software application), and the request can be provided (step 208) to the application module 118. For example, the application module 118 can implement on online messaging system (e.g., a website) that the user can use to create and submit the request. The application module 118 can forward (step 210) the request to the response module 120, which can determine whether or not the request is suitable for an automatic response. If the response module 120 determines that the request is suitable for an automatic response, the response module 120 can search for or identify one or more automatic responses to the request (e.g., by searching the response data 130 database). The identified responses can then be provided (step 212) to the application module 118, which can forward (step 214) the responses to the client device 206.

The client device 206 can then display (step 216) the identified responses for the user. In preferred implementations, the client device 206 is configured (e.g., using the application client) to allow the user to provide feedback (step 218) on the responses. The user can, for example, identify responses as being relevant or irrelevant or as being helpful or not helpful. Such feedback can be sent (step 222) to the application module 118, which can forward (step 224) the feedback to the response data 130 database. For example, the application module 118 can update the response data 130 database to indicate that one or more responses provided to the user were identified as being relevant or irrelevant to the user's initial request.

Finally, if the user is unsatisfied with the automatic responses, the application module 118 can provide (step 226) the user feedback to the review module 122, which can take action to generate an appropriate response to the user. Such action can include, for example, searching the response data 130 database for other possible automatic responses that may be appropriate for the user. The other possible automatic responses could be identified based on additional information included in the feedback from the user (e.g., a revised request). Additionally or alternatively, the review module 122 can contact a customer service representative who can generate a manual response to the user's request. If the manual response is approved by the user and/or by customer service, the response data 130 database can be updated to indicate that the manual response is an approved automatic response for the user's request. This way, when a different user provides the same or similar request at a later time, the manual response can be automatically retrieved from the response data 130 database and provided to the user.

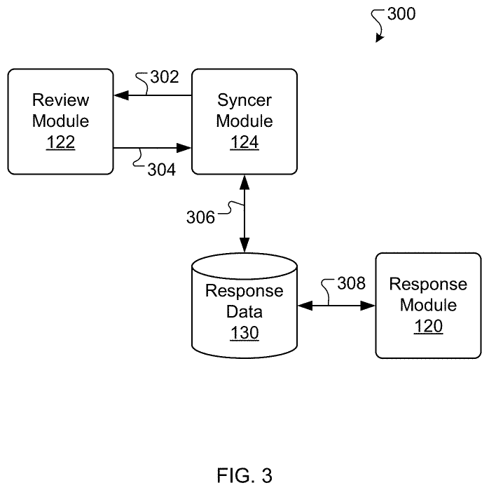

FIG. 3 is a schematic data flow diagram of a method 300 in which the response module 120, the review module 122, and the syncer module 124 are used to develop and/or update the response data database 130. The method 300 can begin when the syncer module 124 sends (step 302) a request (e.g., an application programming interface call) to the review module 122 for any recent user requests, automatic or manual responses to such user requests, and/or any user feedback related to the responses. The review module 122 can provide (step 304) the syncer module 124 with the requested information, and the syncer module 124 can use the information to update (step 306) the response data database 130. For example, the syncer module 124 can update the response data database 130 to include any new mappings between automatic responses and user requests. Additionally or alternatively, the syncer module 124 can update the response data 130 database to include new automatic responses, revise existing automatic responses, and/or remove any automatic responses that are no longer needed or approved (e.g., based on negative user feedback). In some instances, for example, existing automatic responses can be revised to include new words (e.g., acronyms) and/or to describe new features (e.g., associated with the software application). This process in which the syncer module 124 calls the review module 122, receives new request and response information from the review module 122, and uses the information to update the response data 130 database can be performed continuously and/or periodically. For example, the syncer module 124 can call the review module 122 periodically (e.g., every minute, hour, or day) and update the response data 130 database as new information is received from the review module 122. The response module 120 can access (step 308) the response data 130 database, as needed, to process new user requests and search for suitable automatic responses.

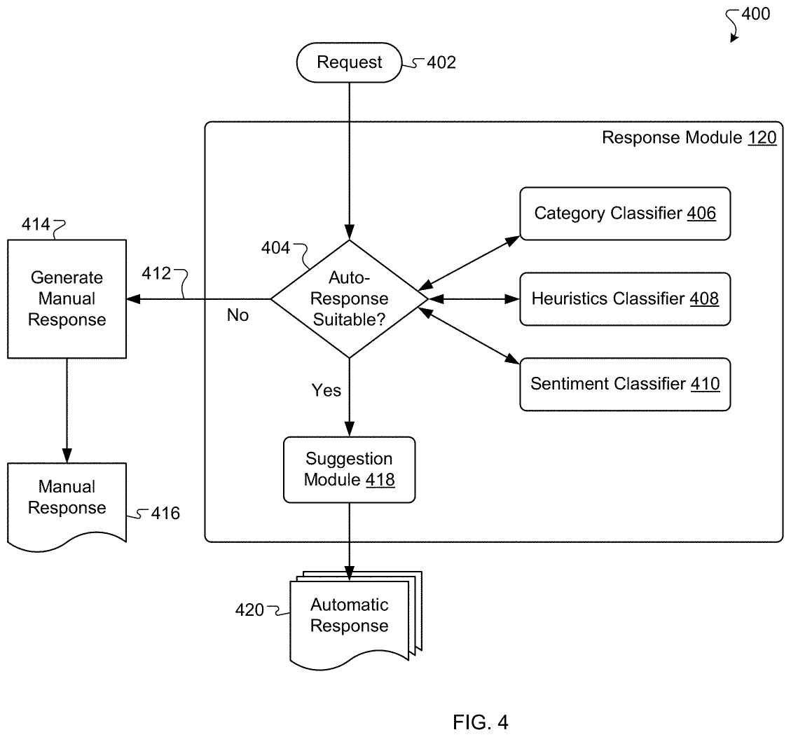

FIG. 4 is a schematic flowchart of a method 400 in which the response module 120 is used to generate automatic responses to requests from users. In the depicted example, the response module 120 receives a user request 402 and determines (step 404) whether or not the user request 402 is suitable for an automatic response. To make this determination, the response module 120 can analyze the user request 402 using one or more predictive models or classifiers. The classifiers can include, for example, a category classifier 406, a heuristics classifier 408, and/or a sentiment classifier 410. Other predictive models or classifiers are possible.

In preferred examples, the category classifier 406 is configured to receive the user request 402 as input and provide as output an indication of a category to which the user request 402 belongs. For example, the category classifier 406 can process the user request 402 to identify a theme or a subject in the user request 402, and the user request 402 can be assigned to a category based on the identified theme or subject. The category classifier 402 can be or utilize a convolutional neural network, for example, with embedding, convolution, max-pool, softmax layers, and/or 400 dimensions. Other classifiers or classifier configurations can be used. The category classifier 406 can be trained using a large set (e.g., thousands or millions) of example requests in which each request is assigned to a category. Such training can be performed at regular intervals (e.g., daily or weekly) as new or additional training data becomes available. The output from the trained category classifier 406 can include predicted probabilities for each category. For example, the category classifier 406 can indicate that the user request 402 has a 90% probability of belonging to a first category and a 10% probability of belonging to a second category. A wide variety of categories can be utilized, depending on the types of requests received and/or the type of software application associated with the requests. Table 1 includes a listing of example user requests and categories related to a software application for a multiplayer online game.

TABLE 1
Example user requests and categories.

| User Request | Category |
|---|---|
| I cannot login to the game account | Account |
| Bought a pack and found some issue | Billing |
| The new game feature is not working | Gameplay |
| I didn't get price for the recent kill event | Events |
| This feature needs to be improved | Feedback |
| The game is lagging a lot | Technical |

In various examples, the response module 120 can be configured to determine (step 404) whether or not the user request 402 is suitable for an automatic response based on the category determined by the category classifier 406. For example, the response module 120 can recognize some categories as being suitable for an automatic response and other categories as being unsuitable for an automatic response. In one example, if the user request 402 relates to a purchase or a refund, the category classifier may assign the user request to a “billing” category, and the response module 120 may determine that the request is not suitable for an automatic response. Additionally or alternatively, if the user request 402 relates to a technical or computer issue, the user request may be assigned to a “technical” category, and the response module 120 may determine that the request is suitable for an automatic response. Other categories can similarly be identified as being suitable or not suitable for automatic responses.

The heuristics classifier 408 can be configured to receive the user request 402 as input and provide as output an indication of one or more characteristics associated with the user request 402. The characteristics can include, for example, a length of the user request 402 (e.g., number of characters or words), an identification of the user who provided the user request 402 (e.g., a user identifier or a client device identifier), and/or a language (e.g., English or Chinese) associated with the user request 402. In some instances, the heuristics classifier 408 can include or utilize a language identification module (e.g., a language classifier) to detect one or more languages in the user request 402. Exemplary language detection techniques are described in U.S. Patent Application Publication No. 2017/0024372, published Jan. 26, 2017, the entire disclosure of which is incorporated by reference herein.

In various examples, the response module 120 can use the output from the heuristics classifier 408 to determine whether or not the user request 402 is suitable for an automatic response. For example, the response module 120 can be configured to provide automatic responses only for some languages (e.g., English) and not provide automatic responses for other languages (e.g., Chinese). In some instances, for example, the response data 130 database may not include automatic responses for certain languages. Additionally or alternatively, the response module 120 can be configured to determine whether or not automatic responses are appropriate based on the length of the user request 402. Message lengths that exceed a certain threshold (e.g., 200, 500, or 1000 characters or words) may be unsuitable for automatic responses and may be more suitable for manual responses. It can be difficult, for example, for an automatic response to adequately address all the issues described in a lengthy user request 402. Additionally or alternatively, the response module 120 can be configured to provide automatic responses only for some users and not provide automatic responses for other users (e.g., based on user identifiers). Automatic responses may be unsuitable for users who are considered to be more valuable or important than other users, for example, due to a long-standing business relationship or a large volume of business or purchases. It can be preferable to provide such users only with carefully crafted manual responses, to avoid the possibility of providing irrelevant automatic responses.

The sentiment classifier 410 can be configured to receive the user request 402 as input and provide as output an indication of any user sentiment that may be expressed in the user request 402. The sentiment may be or include, for example, an opinion or an attitude toward an event or situation, such as a problem with the software application. The sentiment classifier 410 can identify sentiment by performing a sentiment analysis on the user request 402. This can involve, for example, using text analysis, computational linguistics, and/or natural language processing to locate, extract, quantify, and analyze subjective information and affective states included in the user request 402. The sentiment classifier 410 can assess polarity in the user request and/or can identify emotional states such as happy, sad, or angry. In some instances, the sentiment classifier 410 can utilize a rule-based approach to determine if the request has any specific sentiment words (e.g., in a predefined sentiment dictionary). If the request does include one of these words, the request can be considered to have one or more extreme sentiments. In various instances, the sentiment detected by the sentiment classifier 410 can be provided to the response module 120, and the response module 120 can be configured to avoid sending automatic responses when certain sentiments are detected. For example, when the sentiment classifier 410 determines that the user is angry or upset, the response module 120 may determine that the user request 402 is not suitable for an automatic response and/or that a manual response would be more appropriate.

Still referring to FIG. 4, the response module 120 can use output from the category classifier 406, the heuristics classifier 408, and/or the sentiment classifier 410 to determine (step 404) if the user request 402 is suitable for an automatic response. If the response module 120 determines that an automatic response is not suitable, the user request 402 can be forwarded (step 412) to a person 414 (e.g., a customer service representative) who can generate a manual response 416. Alternatively, if the response module 120 determines that the user request 402 is suitable for an automatic response, the user request 402 can be sent to a suggestion module 418, which can search for and provide one or more automatic responses 420. The suggestion module 418 can search a database (e.g., the response data 130 database) to locate the automatic responses 420, for example, using various search techniques (e.g., ELASTICSEARCH).

In various examples, the suggestion module 418 can utilize a term frequency-inverse document frequency (TF-IDF) model to match user requests with automatic responses. The TF-IDF model can be trained to identify an appropriate automatic response to a new request by (i) searching for previous or existing requests (e.g., in the response data 130 database) that are similar to the new request and then (ii) identifying an automatic response that is mapped to (e.g., approved for use with) the previous requests. In other words, rather than attempting to directly match a new request with an automatic response (e.g., based on words in the automatic response), the new request can be matched with one or more previous requests (e.g., based on words in the previous requests) and then mapped to an automatic response assigned to the previous requests. This approach can define an automatic response by the previous requests associated with the automatic response, for example, rather than by the content of the automatic response. In some instances, for example, a new request and a desirable automatic response may not have many words in common. This issue can be avoided by finding one or more previous requests that match the new request and then identifying the automatic response mapped to the one or more previous requests.

Referring to Table 2, each request in a set of previous or existing requests can be mapped to a respective automatic response using a response identifier (ID) associated with the automatic response. For example, the previous request “I have an issue with billing . . . ” can be mapped to an automatic response having a response ID of 1. If a user later submits this exact same request, the suggestion module 418 can determine that the new request matches the previous request and can retrieve the mapped automatic response (e.g., from the response data 130 database). In most cases, however, a user's request may not be a perfect match with any of the previous requests.

TABLE 2
Response IDs and associated user requests and tags.

| Response | | Possible Relevant |
|---|---|---|
| ID | User Requests | Words |
| 1 | I have an issue with billing . . . | issue, billing |
| | Bought a pack and found some issue | pack, issue |
| 2 | The new game feature is not working | game feature, |
| | | not working |
| | I found some issue with the game feature | issue, game |
| | | feature |

To account for such differences, the suggestion module 418 can be used to find a closest match between a new request and one or more previous requests. For example, the suggestion module 418 can implement or utilize a relevance model such as, for example, TF-IDF, BM25 (e.g., Okapi weighting), divergence from randomness (DFR), a language model (LM), or the like. The relevance model can be implemented by indexing each response identifier as a collection of previous requests associated with the response identifier, as indicated in Table 2. When indexed, the requests can be stored as an unprocessed bag of words or tags, for example, in which each tag for a request is a word from the request. Alternatively or additionally, some amount of pre-processing can be performed on the requests, for example, to store only words or tags that have been determined to be important (e.g., heuristically). The extracted tags for a request can be or include, for example, one or more words or phrases, one or more word or phrase frequencies, one or more parts of speech, grammar features, and/or one or more dependency parsed relations. In some examples, tags can be extracted from a request by employing dependency parsing and/or by retaining nouns and/or noun phrases. Alternatively or additionally, rather than using an explicit tag generation mechanism, the relevance model can determine which words in the request are more important than others. For example, a TF-IDF model can determine the importance of each word in a request according to how frequently the word appears within a corpus (e.g., all automatic responses and/or requests for a particular language). Common words in the corpus, such as stop words (e.g., “the,” “a,” “and,” etc.), may be considered to be less important than uncommon or rare words.

Referring to Table 3, user requests associated with the same response ID can be grouped together (e.g., as a single document), and a frequency of tags can be computed for each group. For example, the first group of requests in Table 3 includes the requests “I have an issue with billing . . . ” and “Bought a pack and found some issue.” The tags for this group can include the words “issue,” “billing,” and “pack,” which have frequencies of 2, 1, and 1, respectively, based on a number of times each tag appears in the group. To find a closest match between a new request and a previous request, tags can be extracted from the new request and the TF-IDF model can be used to identify the group of previous requests that has the most similar set of tags. In some instances, for example, each request and/or group of requests can be represented by a vector of tags, in which each element in the vector is assigned to a particular tag and the value of the element indicates the frequency associated with the particular tag. The first, second, and third elements of the vector for the first group of requests in Table 3 could be, for example, the frequencies associated with the tags “issue,” “billing,” and “pack,” such that the vector could include the following elements [2, 1, 1, . . . ]. A vector for a different group that does not include these tags could include the following elements [0, 0, 0, . . .]. In general, each element in the vectors can be assigned to the same tag.

TABLE 3
Response IDs and tag frequencies associated
with groups of user requests.

| Response | | |
|---|---|---|
| ID | User Request Grouping | Tags |
| 1 | I have an issue with billing . . . | issue - 2, |
| | Bought a pack and found some issue | billing - 1, |
| | | pack - 1 |
| 2 | The new game feature is not working | game feature - 2, |
| | I found some issue with the game feature | not working - 1, |
| | | issue - 1 |

Next, to find a match between a new request and a group of previous requests, the relevance model can implement a ranking function such as, for example, cosine similarity. The group of previous requests having the largest cosine similarity with the new request can be considered to be the closest match. In general, a large cosine similarity can indicate that two vectors are oriented in similar directions (e.g., due to similar vector elements) and/or include similar tags or tag frequencies. A small cosine similarity can indicate that two vectors are oriented in different directions (e.g., orthogonal to one another). When a vector for a new request has a high cosine similarity with a vector for a previous group of requests, the new request likely shares many of the same tags that are found in the previous group of requests. The tags and vector representations for groups of previous requests and/or individual previous requests can be stored in the response data 130 database. Once a match has been found between the new request and one or more groups of previous requests, one or more automatic responses 420 mapped to the one or more groups of previous requests can be identified (e.g., based on response IDs) by the suggestion module 418 and provided to the user. In some instances, for example, the suggestion module 418 can rank any matches between the new request and multiple groups of previous requests (e.g., based on calculated cosine similarities for the groups). The rankings can be used to generate a corresponding ranked list of automatic responses. For example, the automatic response corresponding to the group of previous requests that most closely matches the new request can be given a highest ranking.

In preferred implementations, when a new request is matched with a group of previous requests, the group of previous requests can be augmented to include the new request. This allows the group of requests and the associated tags and vectors to be updated or modified as new requests are received and matched with the group. It also allows matching models (e.g., the TF-IDF model) to be continuously improved or updated over time, as tags and/or tag frequencies for groups of requests are updated. In some instances, a group of requests may not be modified to include a new request until user feedback is received confirming that the automatic response provided to the user was relevant or helpful. For example, if a user indicates that an automatic response to a new request was irrelevant or not helpful, the group of previous requests associated with the automatic response may not be modified to include the new request.

In general, the suggestion module 418 can be or include a response ranker model that proposes a ranked suggestion of response IDs, with more relevant response IDs being ranked higher than less relevant response IDs. The model can determine response relevancy by learning from previous requests associated with the same response ID. Internally, each response ID can be indexed as a collection of previous requests associated with the response ID. For any new requests marked with the same response ID, the index representation can be updated to account for the new response. In some examples, requests can be indexed using a relevance model (e.g., a TF-IDF model) as a bag of tags. Tag extraction can be performed using techniques such as, for example, dependency parsing and/or part-of-speech (POS) tagging. The tag extraction can be performed for requests that are in any language, or the tag extraction approach can be reserved for only certain languages (e.g., English). Alternatively or additionally, rather than performing an explicit tag extraction, the relevance model can determine which words are more important than others. With this approach, the response IDs can be indexed as bags of words.

Table 4 presents an example in which Response ID=1 is associated with existing requests related to billing issues and packs or purchases for an online game, and Response ID=2 is associated with existing requests related to performance issues for the online game. When a new request is received that includes words or tags related to packs (e.g., “Some items are missing from the pack”), the response ranker model can conclude that the words/tags for the new request are more relevant or similar to the words/tags for Response ID=1 than for Response ID=2 (e.g., based on cosine similarity). Accordingly, the response ranker model can rank Response ID=1 higher than Response ID=2, and the automatic response associated with Response ID=1 can be provided to the user who submitted the new request. In this example, each response ID and/or all of the Response ID's associated requests can be referred to as a “document,” the set of all active or available responses and/or documents can be referred to as a “corpus,” and/or the new request can be referred to as a “query.”

TABLE 4
Response IDs for existing/previous groups of requests.

| Response | |
|---|---|
| ID | User Requests |
| 1 | I have an issue with the pack I just purchased |
| | I accidentally bought a pack that I no longer need |
| | . . . |
| 2 | The game is noticeably lagging for the last few minutes |
| | My game is frozen |
| | . . . |

As described herein, the suggestion module 418 can utilize or implement various types of relevance models to rank Response IDs by relevance. For example, a TF-IDF model can be used to weigh each word (or each important word) in a query based on (1) a number of occurrences within the document (e.g., term frequency or TF) and (2) rarity of occurrence within the corpus (e.g., inverse document frequency or IDF). Thus, the TF-IDF model can transform both the document and query into N dimensional vectors, in which each unique term or word represents a dimension or element of the vector, and where N can be any suitable number. The TF-IDF model can compute relevance using cosine similarity between the query vector and document vector. Additionally or alternatively, an Okapi or BM25 relevance model can include or utilize a probabilistic ranking function that attempts to rank documents based on relevancy. The ranking function can be dependent on term frequency (TF) and inverse document frequency (IDF); however, the model preferably does not treat documents as vectors. Additionally or alternatively, a divergence from randomness (DFR) relevance model can be utilized. DFR can represent a probabilistic family of ranking models that attempt to measure document importance by determining the document's divergence from a random distribution. A document can be relevant for a given query, for example, when the document presents a term distribution that cannot be attributed to a random or background distribution of terms. Additionally or alternatively, the relevance model can be a language model (LM) that, rather than attempting to measure the relevance of a given document to a query, can model the probability that the query was generated from the given document. In general, the relevance model can be configured to use TF and IDF values and a bag of words/tags to compute relevance. Thus, various types of relevance models (e.g., TF-IDF, BM25, DFR, or LM) can be used interchangeably (e.g., as a black box). In preferred examples, regardless of the specific type of relevance model used for a given user request, the suggestion module 418 can respond with a ranked tuple of response IDs and relevance scores (e.g., one score for each ranked response ID).

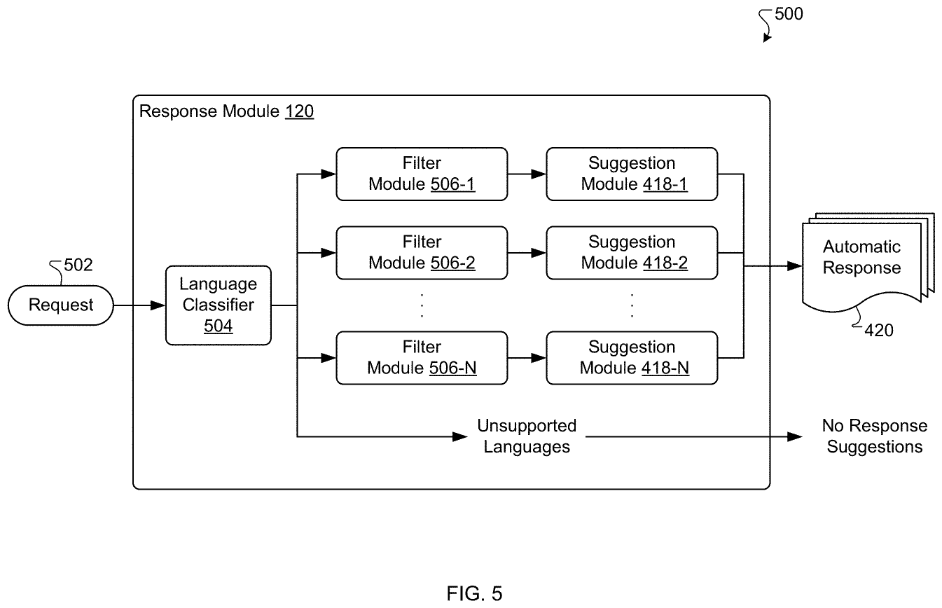

In various examples, the response module 120 can be configured to accommodate user requests received for multiple languages. Referring to FIG. 5, for example, a method 500 of generating an automatic response to a user request 502 can utilize a language classifier 504 within or accessible to the response module 120. The language classifier 504 can utilize language detection techniques, as described herein, to identify a language in or associated with the request 502. Once the language has been identified, the request 502 can be forwarded to a filter module 506 and a suggestion module 418 corresponding to the identified language. In the depicted example, the response module 120 includes N filter modules 506-1 to 506-N and N suggestion modules 418-1 to 418-N corresponding to N different languages, where N can be any suitable number. When the language is identified as being the second language from the N different languages, for example, the request 502 can be processed by the filter module 506-2 and the suggestion module 506-2. In general, each filter module 506 can determine whether the request 502 is suitable for an automatic response, as described herein (e.g., using the category classifier 406, the heuristics classifier 408, and/or the sentiment classifier 410). If an automatic response is determined to be suitable, the suggestion module 418 for the particular language can identify one or more suitable automatic responses 420 to the request. When multiple automatic responses 420 are identified, the automatic responses 420 can be ranked by relevance, for example, according to how closely the request 502 matched the groups of previous requests for the automatic responses.

Alternatively or additionally, in some instances, the language classifier 504 may determine that the request 502 includes a language that is not supported by the response module 120. In that case, the response module 120 may not provide any automatic response suggestions for the request 502 and/or may forward the request to a person (e.g., a customer service representative) who can generate a manual response (e.g., in the appropriate language).

Alternatively or additionally, when the request 502 is in a language that is not supported by the response module 120, the request can be translated into a different language that the response module 120 can handle. Likewise, any automatic responses identified by the response module 120 can be translated into the language present in the request 502. Systems and methods for automatically translating text messages are described in U.S. Pat. No. 9,298,703, issued on Mar. 29, 2016, the entire disclosure of which is incorporated by reference herein.

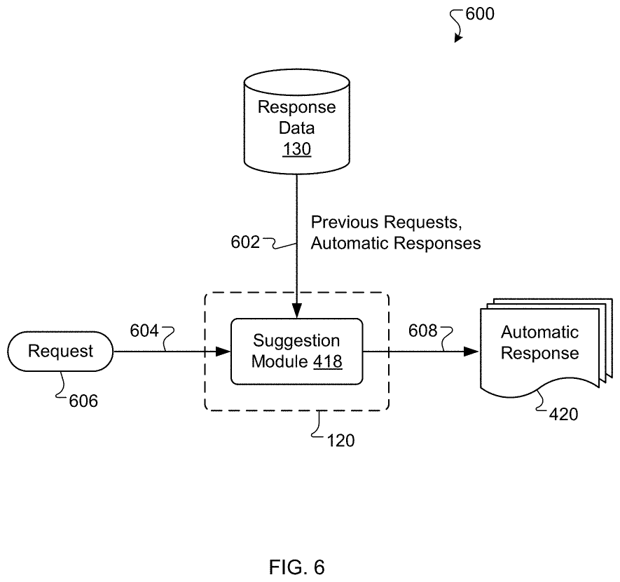

FIG. 6 is a data flow diagram of an example method 600 in which the suggestion module 418 is trained to determine appropriate automatic responses 420 to user requests. The suggestion module 418 can be or include one or more classifiers that are trained periodically (e.g., every day or week) using training data received (step 602) from the response data 130 database. The training data can be or include, for example, a collection of previous user requests and corresponding automatic responses. For example, the training data can identify a suitable or approved automatic response corresponding to one or more previous user requests or groups of user requests. Once trained, the suggestion module 418 can receive (step 604) a user request 606 as input and provide (step 608) as output one or more automatic responses 420 to the user request 606. When providing multiple automatic responses 420, the suggestion module 418 can rank the automatic responses 420 according to a predicted relevance.

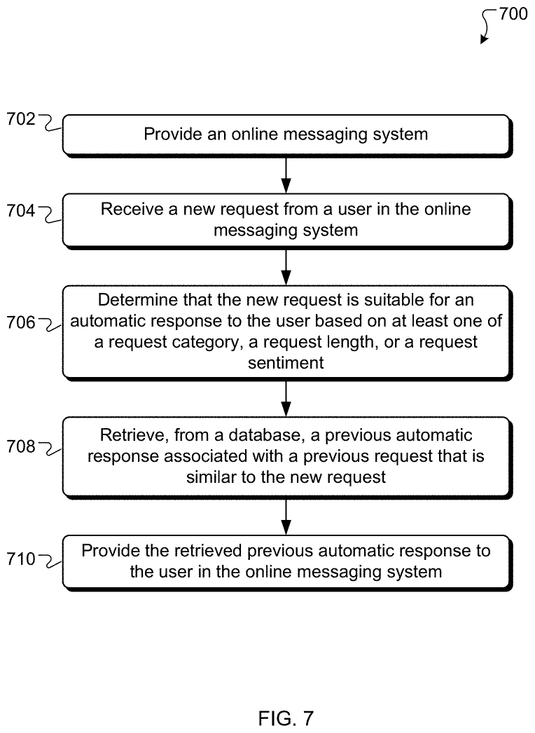

FIG. 7 illustrates an example computer-implemented method 700 of providing automatic responses to requests received from users. An online messaging system is provided (step 702) and a new request (e.g., a text message) is received (step 704) from a user of the online messaging system. The new request is determined (step 706) to be suitable for an automatic response to the user based on at least one of a request category, a request length, or a request sentiment. A previous automatic response associated with a previous request that is similar to the new request is retrieved (step 708) from a database. The retrieved previous automatic response is provided (step 710) to the user of the online messaging system.

While much of the discussion herein relates to providing automatic responses to requests associated with software applications (e.g., for online games), it is understood that the systems and methods are applicable to requests that relate to other subject matter, such as, for example, social media, online shopping, current events, etc. In some examples, the automatic responses can provide technical support and/or customer service for any device, equipment, system, product, or service. The online messaging system described herein can be or include, for example, a website or software application component that allows users to submit requests and receive automatic responses. The requests can be, include, or represent tickets in a customer service system or platform. The automatic responses can be or include macros or response templates for the customer service system or platform.

In various examples, the systems and methods described herein can utilize one or more classifiers or machine-learning models. The classifiers or machine-learning models can be or include, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other classifiers can be used.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing an online messaging system;
receiving a new request from a user in the online messaging system;
determining that the new request is suitable for an automatic response to the user based on at least one of a request category, a request length, or a request sentiment;
retrieving, from a database, a previous automatic response associated with a previous request that is similar to the new request; and
providing the retrieved previous automatic response to the user in the online messaging system.

2. The method of claim 1, wherein the online messaging system is provided to support users of a client application.

3. The method of claim 1, wherein determining that the new request is suitable for the automatic response comprises:
assigning the new request to a category from a plurality of categories; and
determining that the category is suitable for the automatic response.

4. The method of claim 1, wherein determining that the new request is suitable for the automatic response comprises:
determining that a length of the new request is less than a threshold request length.

5. The method of claim 1, wherein determining that the new request is suitable for the automatic response comprises:
performing a sentiment analysis on the new request.

6. The method of claim 1, wherein retrieving the previous automatic response comprises:
searching the database for the previous request that is similar to the new request; and
retrieving the previous automatic response based on a mapping between the previous request and the previous automatic response.

7. The method of claim 6, wherein searching the database for the previous request comprises:
extracting a plurality of tags from the new request; and
calculating a cosine similarity between the plurality of tags for the new request and a corresponding plurality of tags for the previous request.

8. The method of claim 7, wherein at least one tag in the plurality of tags for the new request comprises a word frequency or a phrase frequency.

9. The method of claim 1, further comprising:
updating the database to include a mapping between the new request and the previous automatic response.

10. The method of claim 1, further comprising:
receiving a new automatic response for the online messaging system;
mapping the new automatic response to at least one user request; and
updating the database to include the mapping between the new automatic response and the at least one user request.

11. A system, comprising:
one or more computer processors programmed to perform operations comprising:
providing an online messaging system;
receiving a new request from a user in the online messaging system;
determining that the new request is suitable for an automatic response to the user based on at least one of a request category, a request length, or a request sentiment;
retrieving, from a database, a previous automatic response associated with a previous request that is similar to the new request; and
providing the retrieved previous automatic response to the user in the online messaging system.

12. The system of claim 11, wherein determining that the new request is suitable for the automatic response comprises:
assigning the new request to a category from a plurality of categories; and
determining that the category is suitable for the automatic response.

13. The system of claim 11, wherein determining that the new request is suitable for the automatic response comprises:
determining that a length of the new request is less than a threshold request length.

14. The system of claim 11, wherein determining that the new request is suitable for the automatic response comprises:
performing a sentiment analysis on the new request.

15. The system of claim 11, wherein retrieving the previous automatic response comprises:
searching the database for the previous request that is similar to the new request; and
retrieving the previous automatic response based on a mapping between the previous request and the previous automatic response.

16. The system of claim 15, wherein searching the database for the previous request comprises:
extracting a plurality of tags from the new request; and
calculating a cosine similarity between the plurality of tags for the new request and a corresponding plurality of tags for the previous request.

17. The system of claim 16, wherein at least one tag in the plurality of tags for the new request comprises a word frequency or a phrase frequency.

18. The system of claim 11, further comprising:
updating the database to include a mapping between the new request and the previous automatic response.

19. The system of claim 11, further comprising:
receiving a new automatic response for the online messaging system;
mapping the new automatic response to at least one user request; and
updating the database to include the mapping between the new automatic response and the at least one user request.

20. An article, comprising:
a non-transitory computer-readable medium having instructions stored thereon that, when executed by one or more computer processors, cause the one or more computer processors to perform operations comprising:
providing an online messaging system;
receiving a new request from a user in the online messaging system;
determining that the new request is suitable for an automatic response to the user based on at least one of a request category, a request length, or a request sentiment;
retrieving, from a database, a previous automatic response associated with a previous request that is similar to the new request; and
providing the retrieved previous automatic response to the user in the online messaging system.
